(19) United States
(12) Patent Application Publication
(10) Pub. No.: US 2017/0138789 A1
(43) Pub. Date: May 18, 2017

(54) WAVEGUIDE-BASED INTEGRATED SPECTROMETER

(71) Applicant: ANALOG DEVICES, INC., Norwood, MA (US)

(72) Inventor: Evgueni Ivanov, Lexington, MA (US)

(73) Assignee: ANALOG DEVICES, INC., Norwood, MA (US)

(21) Appl. No.: 15/352,175

(22) Filed: Nov. 15, 2016

Related U.S. Application Data
(60) Provisional application No. 62/255,630, filed on Nov. 16, 2015.
(60) Provisional application No. 62/255,663, filed on Nov. 16, 2015.

(51) Int. Cl. G01J 3/02; G02B 6/122; G02B 6/12; G01J 3/45; G01J 3/18

(52) U.S. Cl. CPC G01J 3/0205; G01J 3/45; G01J 3/18; G02B 6/12004; G02B 6/1223; G02B 2006/12138; G02B 2006/12109

(57) ABSTRACT

Embodiments of the present disclosure provide systems and methods for providing integrated waveguide-based spectrometer systems. In one aspect, the system includes an optical spectrometer comprising one or more waveguides configured to support propagation of optical radiation (i.e. light) through the waveguides to a photodetector. The spectrometer further includes an input coupler for each waveguide, the input coupler configured to couple the radiation from free space into the waveguide in absence of fiber-optic coupling of the radiation into the waveguide. Because at least a portion of the light propagated through the waveguides has interacted with a sample to be spectroscopically evaluated, the light detected by the photodetector allows to carry out the spectroscopic evaluation of the sample. At least some components of the spectrometer are provided on a single die using conventional CMOS techniques, yielding a compact and low cost device.

### CROSS-REFERENCE TO RELATED APPLICATION

This application claims the benefit of and priority from U.S. Provisional Patent Application Ser. No. 62/255,630 filed 16 Nov. 2016 entitled “SPACE-COUPLED WAVEGUIDE-BASED INTEGRATED SPECTROMETER” and U.S. Provisional Patent Application Ser. No. 62/255,663 filed 16 Nov. 2015 entitled “INTEGRATED SPECTROMETER WITH FUNCTION MODULATION” (APD5551-1), each of which is incorporated herein by reference in its entirety.

### TECHNICAL FIELD OF THE DISCLOSURE

The present invention relates to the field of spectrometers, in particular to waveguide-based spectrometers used in integrated circuits.

### BACKGROUND

Spectroscopy is a commonly used analytical technique for chemical analysis and detection as well as for many other applications. Traditionally spectrometers have been expensive and large size instruments intended for applications in analytical laboratories. In the recent years many instrumentation vendors attempted to develop small size and low cost spectrometers for a variety of consumer, medical and industrial applications. These attempts included development of compact discrete optic module spectrometers as well as spectrometers implemented in semiconductor integrated circuits. Because integrated spectrometers fabricated with semiconductor technology promise compact sizes and low production costs, further improvements in this area are always desirable.

### Overview

Embodiments of the present disclosure provide integrated waveguide-based spectrometer systems which are compact, substantially less complex, and relatively inexpensive compared to complex conventional spectrometer equipment. The spectrometer systems described herein may be used in any systems that require determination of presence and, possibly, the amount of a certain chemical component on or in a sample.

In one aspect, the system includes an optical spectrometer comprising one or more waveguides configured to support propagation of optical radiation (i.e. light) through the waveguides to a photodetector. The spectrometer further includes an input coupler for each waveguide, the input coupler configured to couple the light from free space into the waveguide in absence of fiber-optic coupling of the light into the waveguide. Because at least a portion of the light propagated through the waveguides has interacted with a sample to be spectroscopically evaluated, the light detected by the photodetector allows to carry out the spectroscopic evaluation of the sample. At least some components of the spectrometer are provided on a single die using conventional wafer-level semiconductor fabrication techniques, yielding a compact and low cost device.

As will be appreciated by one skilled in the art, aspects of the present disclosure may be embodied in various manners—e.g. as a method, a system, a computer program product, or a computer-readable storage medium. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more processing units, e.g. one or more microprocessors, of one or more computers. In various embodiments, different steps and portions of the steps of each of the examples described herein may be performed by different processing units. Furthermore, aspects of the present disclosure may take the form of a computer program product embodied in one or more computer readable medium(s), preferably non-transitory, having computer readable program code embodied, e.g., stored, thereon. In various embodiments, such a computer program may, for example, be downloaded (updated) to the existing devices and systems (e.g. existing spectroscopic modules and/or their controllers) or be stored upon manufacturing of these devices and systems.

Other features and advantages of the disclosure are apparent from the following description, from the examples, and from the claims.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 illustrates a traditional grating coupler for fiber-to-die coupling;

FIG. 2 illustrates a space-coupled waveguide-based spectrometer system, according to some embodiments of the present disclosure;

FIGS. 3A and 3B illustrate different grating coupler architectures, according to some embodiments of the present disclosure;

FIG. 4A provides a block diagram illustrating an integrated waveguide-based spectrometer system implementing multiple input couplers with their respective waveguides to increase the amount of light provided to a photodetector for analysis, according to some embodiments of the present disclosure;

FIG. 4B provides a block diagram illustrating an integrated waveguide-based spectrometer system implementing different photodetectors to detect light from different spectrometer channels, according to some embodiments of the present disclosure;

FIG. 5A provides a block diagram illustrating an integrated waveguide-based spectrometer system implementing a single photodetector to detect light from different spectrometer channels, according to some embodiments of the present disclosure;

FIG. 5B provides a block diagram illustrating an integrated waveguide-based spectrometer system implementing a single photodetector to detect light from different spectrometer channels, according to other embodiments of the present disclosure; and

FIG. 6 provides a block diagram illustrating an exemplary data processing system for carrying out spectroscopic evaluation of a sample, according to some embodiments of the present disclosure.

### DESCRIPTION OF EXAMPLE EMBODIMENTS OF THE DISCLOSURE

### Basics of Optical Spectrometers

Spectrometers are devices that analyze intensities and other characteristics of received signals as a function of wavelength, frequency, energy, momentum, or mass in order to characterize matter. Optical spectrometers are spectrometers that analyze optical spectrum, i.e. distribution of frequencies or wavelengths, of light received at their optical input. During a spectroscopic measurement, light is incident on a sample (where a sample may be a certain substance, material, or a region in space) and interacts with various atoms and molecules in the sample (e.g. is reflected from the sample, is transmitted through the sample, is partially absorbed by the sample, etc.). At least some of the light that has interacted with the sample eventually reaches a photodetector of the spectrometer, which may include one or more photosensitive elements. Based on the light detected at the photodetector, in particular by measuring intensity or/and polarization state of the received light as a function of a wavelength or any other variable indicative of the wavelength, such as e.g. frequency or energy of the received photons, the spectrometer can detect and quantify presence of various atoms and molecules in the sample. Measurements may be carried out either in relative or in absolute units. In the following, the term “spectrometer” is used to refer to optical spectrometers.

As used herein, the term “detect” is used to describe implementations where mere presence or absence of radiation of a certain characteristic (e.g. of a certain wavelength or a range of wavelengths) is determined, as well as implementations where such radiation is quantified by e.g. measuring intensity of such radiation.

Coupling Radiation into Spectrometers

There is a variety of methods to couple light into an optical input of a spectrometer. Typically the optical connection of spectrometers with the preceding optics can be divided into two categories: fiber-coupled and space-coupled. In space-coupled arrangements, light is directed into the input optical aperture of a spectrometer by means of discrete optical elements such as lenses or by directly receiving optical radiation from the environment. In fiber-coupled arrangements, light is coupled into the input of a spectrometer by means of an optical fiber attached to the optical input of the spectrometer.

Fiber-coupled arrangements typically have higher production cost due to higher cost of fiber components, complicated packaging and costly coupling alignment between the fiber and the spectrometer. In addition, even when multimode fiber with typical diameter of 50-100 micrometers (microns) is used, it is difficult to efficiently focus the incoming radiation on such a small input aperture of the fiber without significant radiation losses. Focusing the incoming light on the input of single-mode fibers with typical core diameter of 10 microns is even more challenging and radiation losses are typically more significant.

In space-coupled arrangements, the incoming light is directly accepted by the input of a spectrometer without any need for sophisticated collimating systems. In absorption spectroscopy schemes where a parallel beam is passed through a sample, a simple lens may be needed to focus light on the light-receiving area of the spectrometer. In bulk-volume emission or reflection spectroscopy arrangements where the incoming light is coming from bulk volumes of a sample within a large solid angle, a focusing lens may not even be necessary. Therefore, space-coupled arrangements are typically easier to use, more application-friendly, have a higher system-level optical throughput and transmittance and bear no extra assembly cost for coupling between the fiber and the optical input of the spectrometer.

### Integration of Spectrometers on a Chip/Die

With the advances of semiconductor IC fabrication technologies, there is an ever-increasing drive to integrate devices of various functionality on a die. In general, the term “die” refers to a small block of semiconductor material on which a particular functional IC structure or circuit is fabricated. Typically, thousands or millions of identical dies are fabricated on a wafer, i.e. each of the dies on a single wafer may be a repeating unit of a semiconductor product that includes any suitable IC. After the fabrication of the semiconductor product is complete, the wafer may undergo a singulation process in which each of the dies is separated from one another to provide discrete “chips” of the semiconductor product. Thus, in some contexts, the term “IC chip,” also referred to as simply a chip or a microchip, refers to a portion of a semiconductor wafer (e.g. after the wafer has been diced/singulated) containing one or more dies. In other contexts, the term “IC chip” sometimes refers to a package in which different dies are assembled. In general, a device, such as e.g. a spectrometer, is referred to as “integrated” if it is provided on one or more dies of an IC chip.

There have been numerous attempts in the prior art to develop integrated spectrometers based on semiconductor fabrication technology.

Some of the attempts use semiconductor die fabricated with custom manufacturing process or use a standard Complementary Metal-Oxide Semiconductor (CMOS) or Bi-CMOS (i.e. technology combining CMOS with bipolar junction transistor) processes with additional custom fabrication steps. Resulting arrangements include, for example, Colloidal Quantum Dot Integrated Spectrometers, Micro-Electro-Mechanical System (MEMS) Integrated Scanning Fourier-Transform Spectrometers, Integrated Scanning Dispersive Spectrometers Based on MEMS Programmable Micromirror Arrays, Scanning Spectrometers Based on MOEMS Piezoelectrically-Tunable Fabry-Perot Interferometers, and Spectrometers Based on Linear Variable (Wedged) Interference Filters. These arrangements are space-coupled and, therefore, have the benefit of lower assembly and optical system-level cost compared to fiber-coupled arrangements. However, due to custom and often complicated fabrication processes, these arrangements have higher die production costs.

On the other hand, there is a variety of waveguide-based spectrometer arrangements based on CMOS-compatible silicon photonics fabrication process that benefit from low die fabrication costs. These arrangements include, for example, integrated planar waveguide spectrometers based on an array of microdonut or micro-ring resonators, or Integrated Dispersive Spectrometers with Integrated Planar Grating or Arrayed Waveguide Grating, with blazed waveguide sidewall grating, with Echelle grating, or with photonic crystal superprism. These arrangements also include Integrated Spectrometers with multimode interferometers, Integrated Fourier-Transform Spectrometers with an array of planar non-modulated or modulated Mach-Zender Interferometers, and Integrated Fourier-Transform Spectrometers with an array of planar non-modulated or modulated Michelson Interferometers. While these arrangements have relatively low die fabrication costs due to CMOS-compatible fabrication, these planar waveguide structures use an on-chip waveguide as an input and require fiber-coupling for receiving the incoming radiation. Using fiber-coupling significantly increases the assembly and optical system costs.

### Proposed Improved Spectrometers

Embodiments of the present disclosure are based on realization that any planar waveguide-based integrated spectrometer can be converted into a space-coupling arrangement by using an input coupler, such as e.g. a grating or a plasmonic coupler, at the optical input of the spectrometer. As used herein, “optical input” of a waveguide-based spectrometer refers to a part or a region of a spectrometer system where light that has interacted with a sample being evaluated is coupled into the waveguide in order to be provided to the photodetector of the spectrometer.

Grating couplers have been developed and traditionally used for fiber-to-die coupling of radiation in photonic circuits. However, the inventor of the present disclosure realized that grating couplers, as well as other type of couplers such as e.g. plasmonic couplers, can also work as space-to-die couplers in integrated spectrometers, eliminating the need to use fiber-optic coupling altogether. In the following, coupling is described with reference to a grating coupler. However, embodiments of the present disclosure may also be implemented using plasmonic couplers, which is within the scope of the present disclosure.

In general, a grating coupler refers to a collection of regularly spaced elongated elements provided over at least a part of a waveguide. Such a collection is used as a phase-matching element for coupling incident light into the waveguide. Grating coupling operates based on guided-mode resonance, a phenomenon where one or more guided modes of a waveguide may be excited in presence of a phase matching grating. Incident light that excites one of the guided modes of a waveguide is coupled into the waveguide. Whether and which radiation components of the incident light are coupled into the waveguide depends, among other things, on the wavelengths and the incident angles of various components of the incident light, geometry/architecture of the waveguide, and geometry/architecture of the input grating coupler. A grating coupler may be viewed as an optical antenna that re-directs at least a part of optical radiation incident on the coupler into a waveguide attached to the output of the grating coupler.

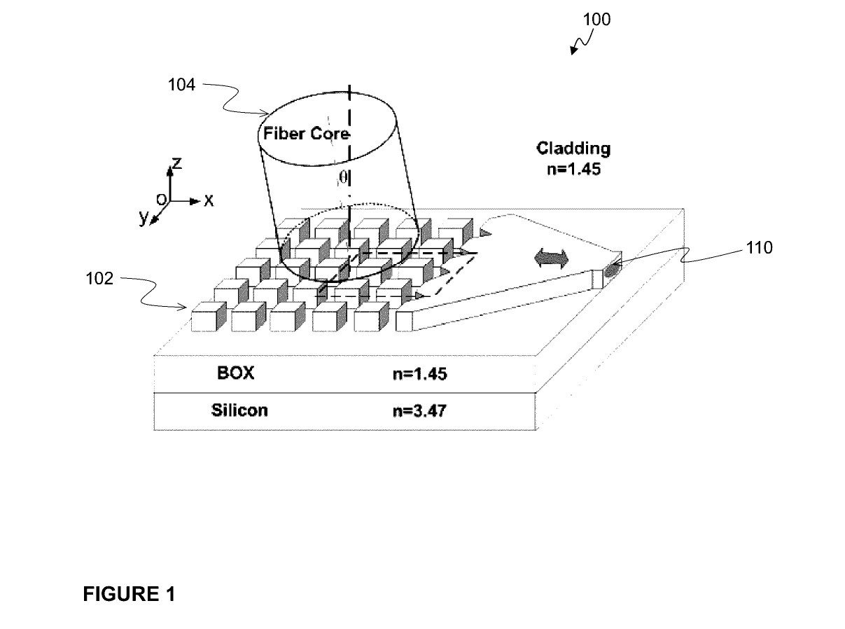

FIG. 1 illustrates a conventional grating coupler for fiber-to-die coupling. As shown in FIG. 1, a grating coupler 102 is used to couple radiation from a fiber core 104 into a waveguide 110.

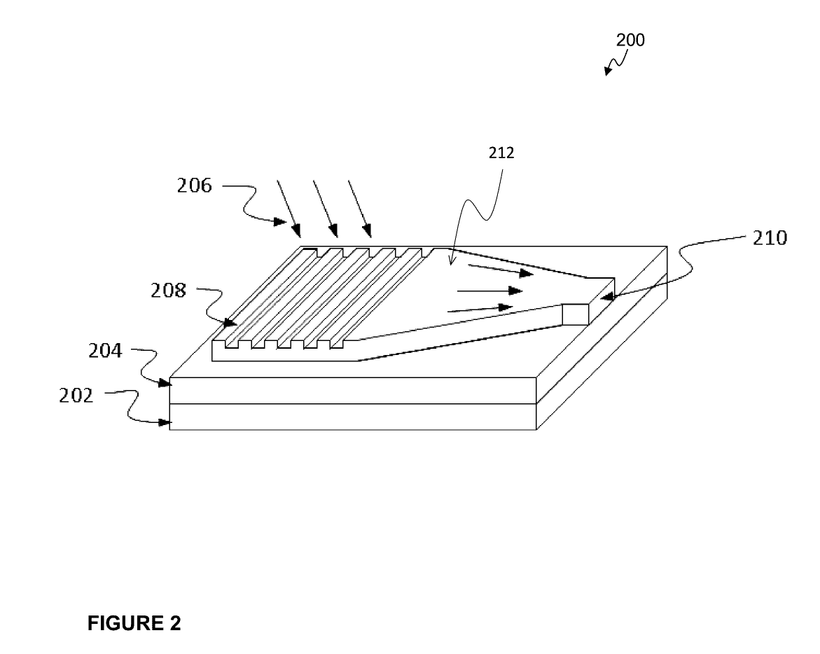

On the other hand, FIG. 2 illustrates a space-coupled waveguide-based spectrometer system 200, according to some embodiments of the present disclosure. The system 200 implements an optical spectrometer that includes a structure 212 provided over a substrate 202.

In some embodiments, the substrate 202 may be a semiconductor substrate. The substrate 202 may include, for example, a crystalline substrate formed using a bulk silicon or a silicon-on-insulator substructure. In some embodiments, the semiconductor substrate 202 may be formed using alternative materials, which may or may not be combined with silicon, that include, but are not limited to, germanium, indium antimonide, lead telluride, indium arsenide, indium gallium arsenide, indium phosphide, gallium arsenide, or gallium antimonide. Further materials classified as group II-VI, III-V, or IV may also be used to form the substrate 202. Although a few examples of materials from which the substrate 202 may be formed are described here, any material that may serve as a foundation on which parts of the spectrometers described herein may be disposed may be used. The substrate 202 may be part of a singulated die or a wafer.

The structure 212 includes an input coupler 208 and a waveguide 210, the waveguide 210 shown in the exemplary illustration of FIG. 2 as a planar, or slab, waveguide. The coupler 208 and the waveguide 210 are made of one or more materials of a higher refractive index surrounded or confined by materials or regions of lower refractive index, shown in the exemplary illustration of FIG. 2 with a cladding material 204 on the bottom of the structure 212 and air on top of the structure 212.

Other parts of the spectrometer which may also be provided over the substrate 202 are not shown in FIG. 2 in order to not clutter this drawing intended to illustrate the grating coupler 208. The spectrometer of the system 200 is configured to support propagation of light through at least a portion of the waveguide 210 to carry out one or more analytical techniques on the received light for determining the spectral content of the received light (i.e. to perform spectroscopic evaluation of a sample with which the light interacted). The coupler 208 is illustrated in the exemplary illustration of FIG. 2 as a grating coupler 208, configured to couple radiation 206 incident on the coupler from free space into the waveguide 210. As shown in FIG. 2, the coupling is done in absence of fiber-optic coupling of light into the waveguide.

Preferably, the input coupler of the system 200 is integrated on a semiconductor die, e.g. by being manufactured as a collection of phase-matching elements made of a material with refractive index exceeding the refractive index of a material fully or partially surrounding it. For instance, the coupler can be made of silicon, germanium, silicon nitride, silicon oxynitride, or one of group II-V semiconductor materials, and the surrounding or partially surrounding material can be silicon dioxide, silicon nitride or silicon oxynitride.

In various embodiments, an input grating coupler may include one or more of a one-dimensional grating pattern with parallel grating patterns, a one-dimensional grating pattern with concave grating patterns, a two-dimensional grating structure with two-dimensional array of circular grating elements, and a two-dimensional grating structure with two-dimensional array of rectangular grating elements. In various embodiments, each one of these grating patterns/structures could be partially or fully etched structures etched in a semiconductor die.

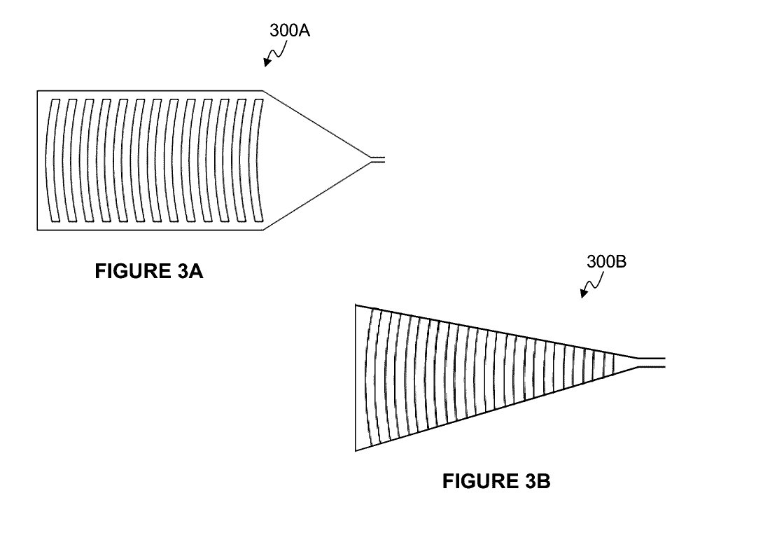

FIGS. 3A and 3B illustrate different exemplary grating coupler architectures, according to some embodiments of the present disclosure. A grating coupler 300A shown in FIG. 3A includes a two-dimensional array of circular grating elements. A grating coupler 300B shown in FIG. 3B is similar to the coupler 300A except that the sidewalls of the coupler have a “flared” structure. In general, a grating coupler may include any type of sidewalls suitable for a particular implementation because it is the geometry of the grating elements itself that has the most impact on the amount of light that a coupler can couple. In some implementations, the coupler 300B may be particularly advantageous because it occupies less of the valuable space on a die. While FIGS. 3A and 3B illustrate that all circular grating elements have the same curvature, in other embodiments, the curvatures may be different, e.g. increasing from left to right, in order to be more efficient in capturing the incident radiation.

While FIG. 2 illustrates a grating coupler, plasmonic couplers may be used as well.

Furthermore, while FIG. 2 illustrates a planar waveguide, various other geometries of the waveguides could be used as well, in other embodiments of the present disclosure. For example, the waveguide of a spectrometer proposed herein could be a strip waveguide or a rib waveguide. Still further, the waveguide could be a photonic crystal waveguide as known in the art.

In addition, while FIG. 2 illustrates incoming radiation incident on the top surface of a waveguide, in other embodiments, radiation may be incident on the bottom surface of the waveguide. In various embodiments a cladding material with lower refraction index such as silicon dioxide, silicon nitride or silicon oxynitride can be placed, or the waveguide may have no cladding material above. Also, the waveguide may be placed on top of a layer of a cladding material with lower refraction index such as silicon dioxide, silicon nitride or silicon oxynitride, and the layer of the cladding material may be placed on the semiconductor, glass, crystal or polymer substrate.

In various embodiments, the higher-refractive index material of the waveguide could be made of silicon, silicon nitride (Si₃N₄), silicon oxynitride (SiON), germanium (Ge), or various III-V semiconductor compounds, such as, but not limited to, gallium arsenide (GaAs), gallium nitride (GaN), gallium phosphide (GaP), indium arsenide (InAs), indium nitride (InN), or indium phosphide (InP).

In various embodiments, the waveguide of the integrated spectrometers described herein could be single-mode, or multi-mode waveguides.

One of the most important characteristics of a spectrometer is its signal-to-noise ratio (SNR).

In some spectrometers, the dominant source of noise is the photodetector noise. In such spectrometers, the noise of a typical semiconductor photodetector usually increases with photodetector area, and, therefore, the photodetector area should be minimized in order to maximize the SNR. On the other hand, the light coupled into the spectrometer is proportional to the area of the grating coupler, and, therefore, that area should be maximized in order to maximize the SNR.

In other spectrometers, the dominant source of noise is the Shot noise of the received radiation. In such spectrometers, the SNR increases with increasing intensity of the received radiation, and the intensity of the received radiation increases with increasing area of grating couplers.

As the foregoing illustrates, the SNR of a spectrometer increases when the area of grating couplers increases. However, increasing the area of a grating coupler increases the intensity of the received radiation only up to a certain limit of the grating coupler length (typically around 30-50 wavelengths). Therefore, it is not possible to increase the SNR of a spectrometer by making the dimensions of the grating couplers very large. Some embodiments of the present disclosure address this issue.

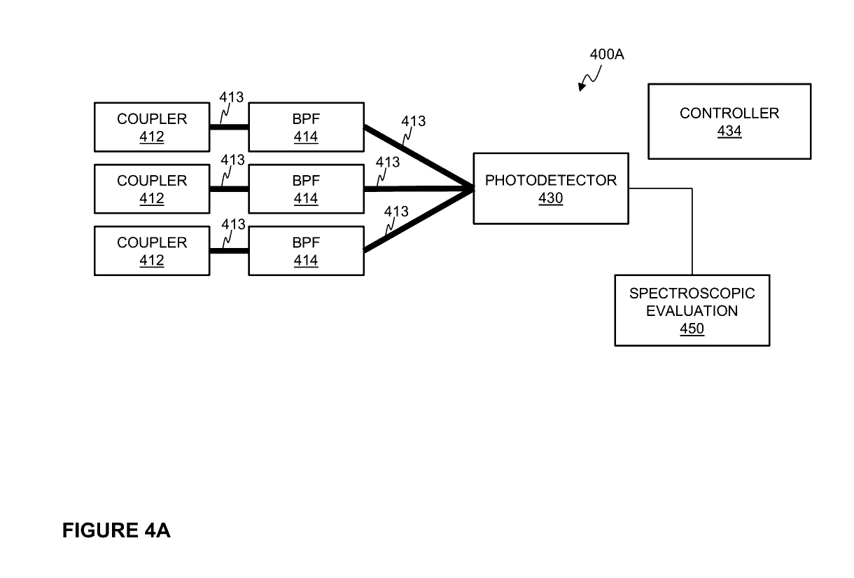

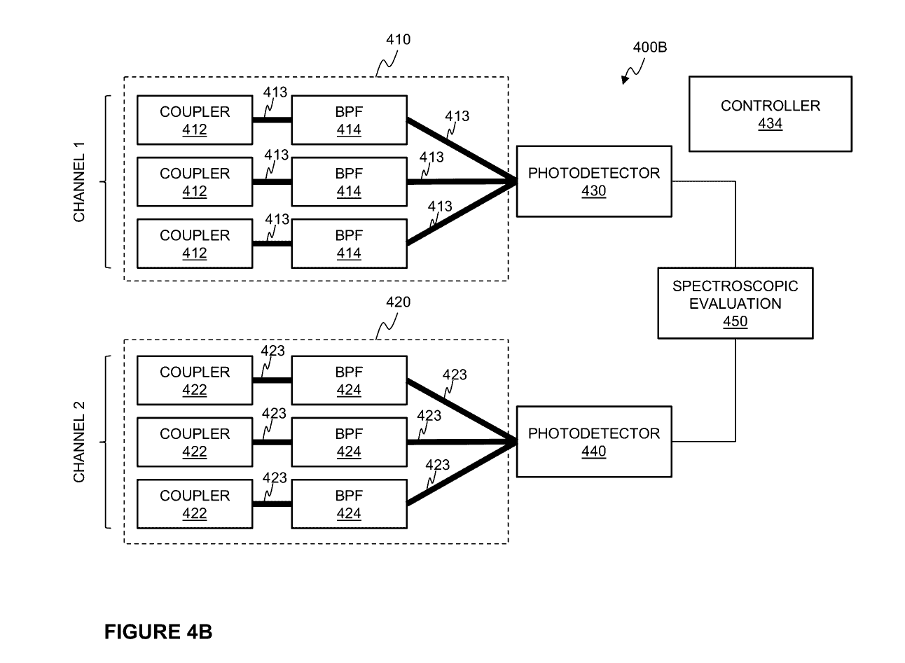

In some embodiments, in order to get as much light onto a photodetector as possible and thereby increase the spectrometer SNR, more than one input couplers, with their respective waveguides, may be used in parallel. In such embodiments, preferably the light captured by each input coupler is not combined until the waveguide is connected to the photodetector, in order to prevent destructive interference of light captured by different input couplers before that light reaches the photodetector. This is illustrated in a schematic diagram of FIG. 4A by showing a spectrometer system 400A where three identical input couplers 412 may be used to couple light and provide the light to a photodetector 430. The light coupled by each input coupler 412 is propagated via a respective waveguide 413 (i.e. for each input coupler there is a respective waveguide), the waveguides 413 indicated in FIG. 4A with thick lines. As shown in FIG. 4A, all of the waveguides 413 are individually connected to the photodetector 430 so that the light propagated in one waveguide does not interfere with the light propagated in any other waveguides.

Each of the couplers 412 may include one of the input couplers as described herein, e.g. any one of the input couplers discussed with reference to FIGS. 2 and 3A-3B configured to couple light from free-space into the waveguide provided on a substrate, in absence of fiber-optic coupling.

One benefit of using a proposed integrated planar waveguide-based spectrometer with grating or plasmonic input coupler configured to couple light from free space is that using space-to-die coupling allows to significantly reduce spectrometer package assembly costs and overall system costs by avoiding all additional costs associated with fiber optic components, their alignment, and their coupling with the semiconductor die. Avoiding fiber optic components will also make the optical spectrometer system more compact and easier to use. Another benefit is high optical throughput or etendue (i.e. a measure of how spread out the light is in terms of area and angle) due to relatively large area and large solid angle of acceptance of such couplers.

Similarly, each of the waveguides 413 may include any one of the waveguides described herein. In some embodiments, the waveguides 413 may be implemented as planar, or slab, waveguides. In other embodiments, various other geometries of the waveguides could be used as well. For example, the waveguides 413 could be implemented as strip waveguides or rib waveguides, or any combination of planar, strip, and rib waveguides. Still further, the waveguides 413 could include photonic crystal waveguides as known in the art.

In some embodiments, the waveguides 413 may be made of one or more materials of a higher refractive index surrounded or confined by materials or regions of lower refractive index, e.g. with a cladding material on one side and air (i.e. refractive index is equal to 1) on the other side of the material of the higher refractive index, or with a cladding material on each side (same or different materials), in case of slab waveguides. In various embodiments, the incoming radiation may be incident on top surfaces of the waveguides 413, on the bottom surfaces of the waveguides, or both. In various embodiments a cladding material with lower refraction index such as silicon dioxide, silicon nitride or silicon oxynitride can be placed, or the waveguide may have no cladding material at least on one side (i.e. air). Also, the waveguides may be placed on top of a layer of a cladding material with lower refraction index such as silicon dioxide, silicon nitride or silicon oxynitride, and the layer of the cladding material may be placed on the semiconductor, glass, crystal or polymer substrate.

In various embodiments, the higher-refractive index material of the waveguides 413 could be made of silicon, silicon nitride (Si₃N₄), silicon oxynitride (SiON), germanium (Ge), or various III-V semiconductor compounds, such as, but not limited to, gallium arsenide (GaAs), gallium nitride (GaN), gallium phosphide (GaP), indium arsenide (InAs), indium nitride (InN), or indium phosphide (InP).

In various embodiments, the waveguides 413 could be single-mode, or multi-mode waveguides.

In various embodiments, the photodetector 430 could include one, a plurality of, or any combination of a Si photodetector, a Ge photodetector, an InGaAs photodetector, an InAs photodetector, a PbS photodetector, an InSb photodetector, a HgCdTe photodetector, a PbSe photodetector, a GeAu photodetector, a thermistor, a bolometer, a thermocouple, and a pyroelectric detector.

FIG. 4A further illustrates that the light propagated through each waveguide 413 may, optionally, be subject to optical filtering performed by a respective optical filter (i.e. a separate filter provided for each waveguide), shown in FIG. 4A as band-pass filters (BPF) 414 provided for each of the waveguides 413. In various embodiments, some of the optical filters 414 may be implemented as Lyot filters. For example, some of the optical filters 414 may be implemented as an array of planar photonic bandpass Lyot filters. Each bandpass Lyot filter can be implemented as a cascade of comb filters that have harmonic spectral transfer function. In some embodiments, each Lyot filter may include a cascade of serially connected directional couplers acting as comb filters (e.g. through-port directional couplers, drop-port directional couplers or combination of through-port and drop-port directional couplers). In other embodiments, each Lyot filter may include a cascade of serially connected Mach-Zender interferometers acting as comb filters. In some embodiments, some of the optical filters 414 may be implemented as modulated or non-modulated ring resonators, multimode interferometers, or Bragg grating assisted contra-directional couplers. Each of optical filters 414 may be implemented a cascade of optical filters in order to improve the extinction ratio of a resonator filter.

Although not specifically illustrated in FIG. 4A, in other embodiments, each waveguide 413 of the spectrometer 400A may also be associated with an output coupler configured to couple the light from the waveguide 413 out and onto the photodetector 430, e.g. in case the photodetector 430 is provided on a separate die from the input couplers 412 and the waveguides 413. Thus, an output coupler would be included in the light path right before the photodetector 430 but after all of the other components implemented to process the light propagated through the waveguide in some manner (e.g. after the optical filters 414 and before the photodetector 430). Output couplers are also described in greater detail below.

Although also not specifically shown in FIG. 4A, the system 400A may further include or be communicatively connected to one or more analog to digital converters (ADCs) communicatively connected to the photodetector 430 and configured to generate digital representation of radiation detected by this photodetector.

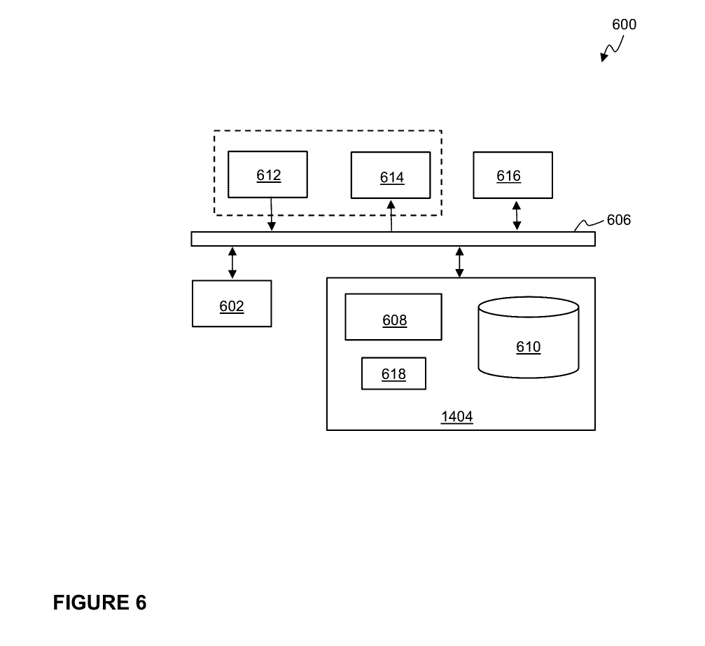

FIG. 4A further illustrates a spectroscopic evaluation logic 450 configured to receive light measurements from the photodetector 430, possibly converted to digital signals using one or more ADCs described above, and perform spectroscopic evaluation of the sample with which the light interacted. FIG. 6 described below provides an example of a data processing system which may be used to implement the functionality of the spectroscopic evaluation logic 450.

FIG. 4A also illustrates that the spectrometer system 400A may further include a controller 434 configured to control and/or enable functionalities described herein. For example, the controller 434 may be configured to control functionality of the photodetector 430 (e.g. sensitivity of photodetector, threshold level, etc.) or control functionality of the ADCs. FIG. 6 described below provides an example of a data processing system which may be used to implement the functionality of the controller 434.

While FIG. 4A illustrates three waveguides, in other embodiments, any other number of input couplers 412 and their corresponding waveguides and other components provided in the path of the waveguides (e.g. optical filters, output couplers, etc.) may be used. Furthermore, the system 400A may further include other components not specifically shown in order to not clutter the drawing.

In some embodiments, at least some parts of the spectrometer system 400A may be integrated on a single die. For example, the set of waveguides 413 may be implemented on a single die with the input couplers 412. If present, the optical filters 414 may be implemented on the same die as well. Furthermore, the photodetector 430 may also be implemented on the same die, or be provided on an adjacent die.

The spectrometer system 400A shown in FIG. 4A illustrates an embodiment where multiple parallel paths are used to collect and process light in a single channel of a spectrometer, i.e. where the components associated with the different waveguides 413 (e.g. the input couplers, the optical filters, the optional output couplers, etc.) are all substantially the same and perform the same function. On the other hand, a spectrometer system 400B shown in FIG. 4B illustrates that, in some embodiments, more than channel may be used in a single spectrometer.

In general, there are various reasons for dividing radiation into channels for spectroscopic evaluation, and, therefore, different criteria as to which channel a particular component of the incoming radiation should belong or be provided to. For example, in a simple and illustrative case, incoming radiation analyzed by a spectrometer may be divided into channels based on the wavelengths. In other words, in some implementations, each channel may be associated with a certain sub-range of wavelengths of the incoming radiation. The wavelength sub-ranges of different channels may be overlapping or not. A different photodetector may then be configured to measure the intensity of the radiation in the respective spectral sub-range of each channel. For example, one photodetector could be configured to measure radiation in a first sub-range of wavelengths of the incoming radiation (i.e. first channel; e.g. wavelengths equal to or greater than 0.2 micrometers (um) and less than 0.3 um), a second photodetector could be configured to measure radiation in a second sub-range of wavelengths (i.e. second channel; e.g. wavelengths equal to or greater than 0.3 um and less than 0.4 um, in case first and second channels are not overlapping), a third photodetector could be configured to measure radiation in a third sub-range of wavelengths (i.e. third channel; e.g. wavelengths equal to or greater than 0.4 um and less than 0.5 um, in case second and third channels are not overlapping), and so on.

In other waveguide-based spectrometer implementations, incoming radiation may be divided into channels based on other criteria. For example, a spatial Fourier transform spectrometer (FTS) divides incoming radiation into channels, but these channels do not correspond to sub-ranges of wavelengths. Instead, in these spectrometers, different channels carry portions of the incoming radiation that passed through respective filters with harmonically-modulated transfer functions. In other words, some spectrometer arrangements have channels with transfer function of each channel being in a form of a respective bandpass filter (i.e., these arrangements divide the incoming radiation based on sub-ranges of wavelengths), while other arrangements, such as e.g. FTS, have channels with transfer functions e.g. in a form of harmonic comb filters. Still other manners of dividing radiation into channels are possible and are within the scope of the present disclosure.

The exemplary system 400B shown in FIG. 4B illustrates two channels—a channel 410 and a channel 420. Each channel collects and provides radiation to a respective photodetector, as shown in FIG. 4B with photodetectors 430 and 440. As shown in the example of FIG. 4B, each channel may include a plurality of waveguides for the purpose of increasing SNR as described above with reference to FIG. 4A, shown as waveguides 413 for the first channel and waveguides 423 for the second channel, the waveguides 413 and 423 indicated in FIG. 4B with thick lines. In fact, the first channel 410 shown in FIG. 4B includes all of the elements shown and described above with reference to FIG. 4A (their description, therefore, is not repeated here). Thus, the first channel 410 includes a plurality of input couplers, in the example of FIG. 4B—three input couplers 412, with their associated waveguides 413, which guide light collected by the couplers 412 onto a photodetector 430. The second channel 420 includes a plurality of input couplers, in the example of FIG. 4B—three input couplers 422, with their associated waveguides 423, which guide light collected by the couplers 422 onto the photodetector 440. Each of the couplers 412 and 424 may include one of the input couplers as described herein, e.g. any one of the input couplers discussed with reference to FIGS. 2 and 3A-3B configured to couple light from free-space into the waveguide provided on a substrate, in absence of fiber-optic coupling. Similarly, each of the waveguides 413/423 may include any one of the waveguides described herein.

Similar to FIG. 4A, FIG. 4B further illustrates that the light propagated through each waveguide 413/423 may, optionally, be subject to optical filtering performed by a respective optical filter (i.e. a separate filter provided for each waveguide), shown in FIG. 4B as band-pass filters (BPF) 414 provided for each of the waveguides 413 of the first channel 410 and BPF 423 provided for each of the waveguides 423 of the second channel 420.

In the embodiments where different channels of the spectrometer 400B may differ by the wavelengths of light that they are configured to couple and propagate to the photodetectors of the spectrometer, the center wavelength of the input couplers 412/424 in different channels may be tuned to different values, while the input couplers in each single channel are all tuned to the same wavelength. Similarly, optical filters 414/424 in different channels may be configured to pass different bands of wavelengths, while the filters within each channel are all configured to pass the same band of wavelengths. Thus, in general, the input couplers 412 may be substantially identical to one another and the input couplers 422 may be substantially identical to one another, but the input couplers 412 are different from the input couplers 422. Similarly, the optical filters 414 may be identical to one another and the optical filters 424 may be identical to one another, but the optical filters 414 are different from the optical filters 424. Taking into consideration these differences between the channels, descriptions provided above for the components of the first channel 410 with reference to FIG. 4A (e.g. descriptions of the input couplers 412, the waveguides 413, the optical filters 414, and other component which may be included between the input couplers and the respective photodetector) are applicable to the components of the second channel 420, and, therefore, are not repeated here. Furthermore, while FIG. 4B illustrates division into channels where each channel includes multiple sub-channels (i.e. multiple individual waveguides 413 or waveguides 423) for increasing the SNR of the collected radiation, in other embodiments, instead of three waveguides shown for each channel in FIG. 4B, each channel may include only a single waveguide with a set of associated components.

Similar to FIG. 4A, FIG. 4B further illustrates a spectroscopic evaluation logic 450 configured to receive light measurements from the photodetectors 430 and 440 and perform spectroscopic evaluation of the sample with which the light interacted. Furthermore, FIG. 4B illustrates a controller 434 configured to control and/or enable functionalities of the spectrometer system 400B described herein, e.g. control how incoming radiation is divided into channels (e.g. by controlling transfer functions of individual waveguides in each of the channels 410/420), control functionality of the photodetectors 430 and 440 (e.g. sensitivity of photodetectors, threshold levels, etc.), control functionality of the ADCs, etc. FIG. 6 described below provides an example of a data processing system which may be used to implement the functionality of each of the spectroscopic evaluation logic 450 and the controller 434 shown in FIG. 4B.

In some embodiments, at least some parts of the spectrometer system 400B may be integrated on a single die. For example, the first and the second sets of waveguides 413/423 may be implemented on a single die with the input couplers 412/424. If present, the optical filters 414/424 may be implemented on the same die as well. Furthermore, the photodetectors 430 and 440 may also be implemented on the same die, or be provided on an adjacent die.

Thus, in some embodiments, the entire spectrometer system 400B may be integrated on the same semiconductor die as the input couplers 412/424. In other embodiments, parts of the spectrometer, such as e.g. one of more of spectrometer photodetectors, may be implemented on a separate die. In still other embodiments, the entire spectrometer may be integrated on one or more dies different from the die on which the input couplers 414/424 are integrated.

In some embodiments, the spectrometer system 400B may be configured to have a transfer function that distinguishes between different polarizations of light. In other words, such a spectrometer may have different radiation transmission characteristics, such as e.g. channel center wavelength position, depending on whether polarization (i.e. direction of oscillation of the electric field of radiation) is parallel or orthogonal to the plane of the incidence of light. Radiation for which the electric field oscillates in the direction parallel to the plane of incidence is referred to as radiation having a Transverse Magnetic (TM) polarization, while radiation for which the electric field oscillates in the direction orthogonal to the plane of incidence is referred to as having a Transverse Electric (TE) polarization. Since a coupler may receive and couple into the waveguide radiation both of TE and TM polarizations, in various embodiments, the spectrometer system 400B may include a polarizer or polarization splitter, not specifically shown in FIG. 4B, in order to ensure that only one type of radiation polarization is sensed by the photodetectors 430/440 of the spectrometer. In some embodiments, such a polarizer or polarization splitter may be integrated on the same die as the input couplers 412/424 and/or on the same die as the waveguides 413/423. In other embodiments it may be implemented on a separate die or as a discrete component of an optical module that includes the spectrometer system 400B. A similar polarizer or polarization splitter may also be included in the spectrometer system 400A of FIG. 4A.

The arrangement shown in FIG. 4B is simplified for illustration purposes, showing only two channels, with three sub-channels within each channel. Of course, in other embodiments, any number of channels (e.g. more than two channels) and any number of sub-channels per each channel (e.g. one sub-channel per each channel) may be used, all of which are within the scope of the present disclosure.

In various embodiments, the BPFs such BPFs 414 and 424 may be implemented as a single unit or an array of waveguide-based units, where a single unit may be implemented as an array of non-modulated micro-ring resonators, an array of Bragg grating assisted contra-directional couplers, an integrated dispersive spectrometer with integrated planar grating, arrayed waveguide grating, blazed waveguide sidewall grating, Echelle grating, an integrated dispersive spectrometer with photonic crystal superprism, multimode interferometer, an array of planar non-modulated Mach-Zender interferometers, an array of planar modulated Mach-Zender interferometers, an array of planar non-modulated Michelson interferometers, an array of planar modulated Michelson interferometers.

### Decreasing the Number of Photodetectors Used in a Spectrometer

The foregoing description illustrates that some waveguide-based spectrometers may divide the incoming radiation into channels and use a separate photodetector to detect/measure radiation received via each channel, as e.g. illustrated with separate photodetectors 430 and 440 shown in FIG. 4B. In some implementations, use of a separate photodetector for each spectrometer channel may not be the most optimal approach, as descried in greater detail below.

Several exemplary reasons for dividing light evaluated by a spectrometer into channels were described above. Regardless of the reason for dividing radiation into channels, what all of these implementations have in common is that radiation of each channel of a waveguide-based spectrometer propagates via a respective different waveguide, exiting at its respective optical output, and is measured by a respective different photodetector at that optical output. In order to measure radiation exiting each spectrometer channel with a different photodetector, an array of photodetectors, such as e.g. an array of two photodetectors, photodetectors 430 and 440 shown in FIG. 4B, may be used.

As with any detectors, the choice of a type of photodetectors used depends, first of all, on the wavelengths of radiation that each photodetector should be able to measure. For example, in the 0.2-1.1 um spectral range (i.e. a range of radiation having wavelengths between 0.2 and 1.1 um), silicon (Si) photodetector arrays can be used. However, due to the energy-band structure of silicon, Si photodetectors are not suitable for detecting radiation of wavelengths beyond 1.1 um. Instead, germanium (Ge) photodetector arrays can be used for detecting radiation of wavelengths beyond 1.1 um and up until about 1.7 um. In fact, due to the energy-band structure of germanium, Ge photodetectors can be used for detecting radiation in the 0.7-1.7 um.

The fact that some waveguide-based spectrometers have a large number of optical outputs, each necessitating an individual photodetector, is not problematic for radiation in the 0.2-1.7 um range because in that range Si and Ge photodetector arrays may be used and those arrays can be integrated with photonic waveguide-based structures on the same die or in a multi-die package in a manner that does not significantly increase production costs. However, Si and Ge photodetectors are not suitable for detecting radiation in spectral regions with wavelengths above 1.7 um (i.e. infrared). In these ranges, different types of detectors have to be used such as e.g. InGaAs, InAs, PbS, InSb, HgCdTe, PbSe, GeAu, thermistors, bolometer, thermocouples or pyroelectric detectors. In contrast to Si and Ge photodetectors, implementing an array of such detectors significantly increases production costs.

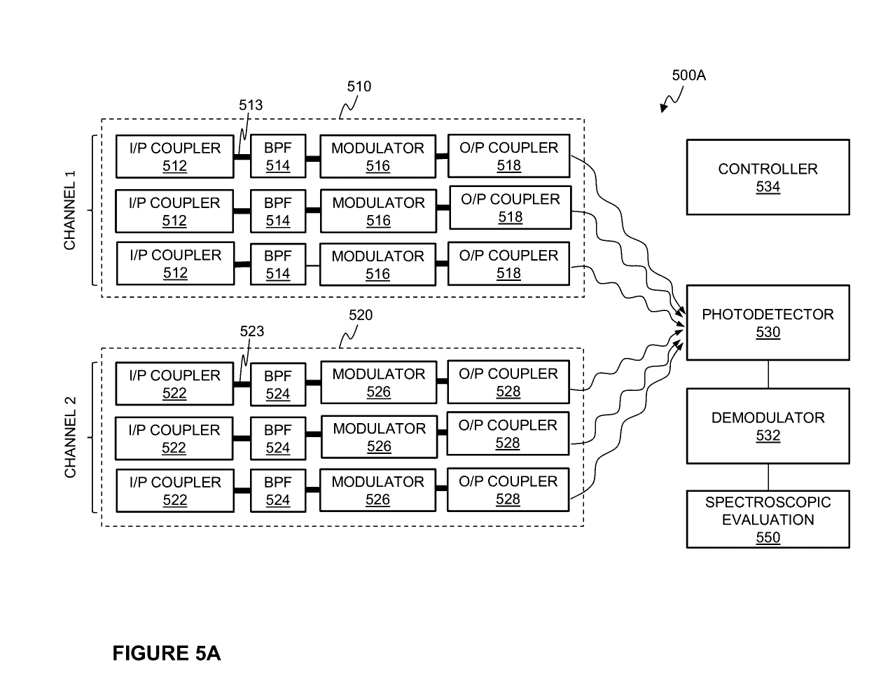

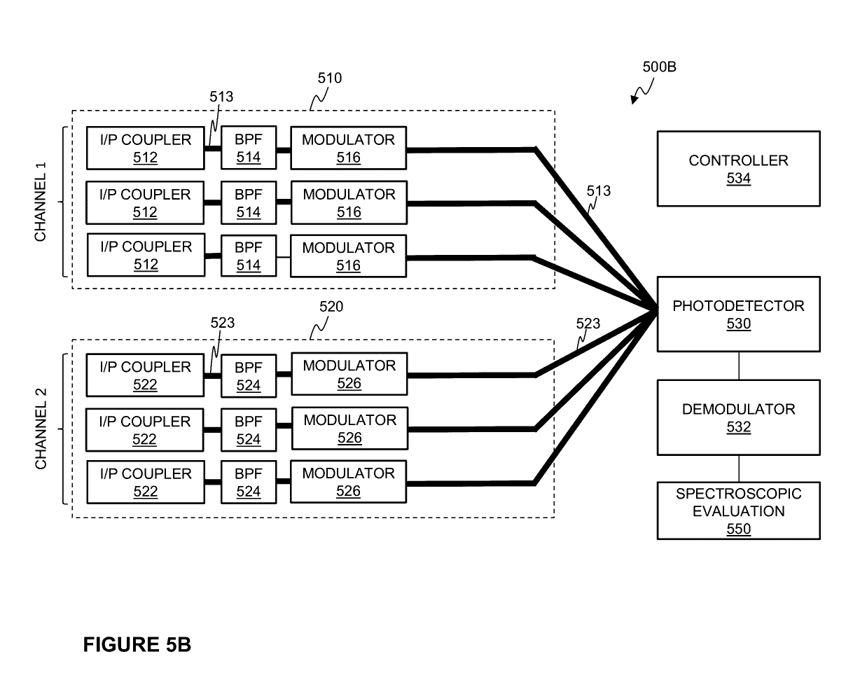

FIGS. 5A and 5B provide block diagram illustrating an integrated waveguide-based spectrometer system 500A and 500B, respectively, implementing a single photodetector 530 to detect light from two or more different spectrometer channels, according to two different embodiments of the present disclosure. As the foregoing description illustrates, reducing the number of photodetectors used in a system, so that less photodetectors are used than a total number of different channels, may provide an improvement, especially with respect to providing integrated waveguide-based spectrometers capable of measuring radiation of different channels at wavelengths beyond 1.7 um.

FIGS. 5A and 5B are similar to FIGS. 4A and 4B, where like reference numerals represent like parts. For example, reference numerals 410 and 510, shown, respectively, in FIGS. 4A-4B and 5A-5B refer to the set of waveguides and associated components of a first channel, reference numerals 420 and 520—to waveguides and associated components of a second channel, reference numerals 412/422 and 512/522—to input couplers of the first/second channels, reference numerals 413/423 and 513/523—to waveguides of the first/second channels, reference numerals 414/424 and 514/524—to optional optical filters of the first/second channels, reference numerals 450/550—to a spectroscopic evaluation logic, and so on. When provided with reference to one of the FIGS. 4A-4B and 5A-5B, discussions of these elements are applicable to other figures, unless stated otherwise. Thus, in the interests of brevity, discussions of similar elements are not repeated for each of FIGS. 4A-4B and 5A-5B but, rather, the differences between the figures are described. In order to not clutter the drawing of FIGS. 5A-5B, not all of the waveguides 513 and 523 are individually labeled with a reference numeral, but the waveguides are indicated in FIGS. 5A and 5B with thick lines and descriptions provided above make clear which waveguides belong to which channel.

Similar to FIG. 4B, in FIGS. 5A and 5B, each set of waveguides 513/523 is configured to support propagation of at least a portion of the incoming optical radiation coupled into the waveguides by the corresponding input couplers 512/522, thus forming optical channels 510 and 520 configured to allow analysis of the spectral content of the incoming optical radiation. Also similar to FIG. 4B, each of the channels 510 and 520 may, optionally, include optical filters in the path of the waveguides 513/523, as shown in FIGS. 5A and 5B with an optical filter 514 provided for each waveguide 513 and an optical filter 524 provided for each waveguide 523. Discussions provided above for the optical filters 414/424 are applicable to the optical filters 514/524 and, therefore, are not repeated here.

Unlike FIGS. 4A and 4B, as shown in both FIGS. 5A and 5B, in addition to the input couplers 512/522, each of the systems 500A and 500B includes modulators 516/526, with a respective modulator associated with/corresponding to each waveguide. In other implementations, the modulators 516/526 may be implemented as any number of one or more modulators configured to provide modulating functionality as described herein.

For both FIGS. 5A and 5B, the one or more modulators 516/526 are configured to apply modulation to the portions of the incoming optical radiation propagated via the two or more sets of waveguides, e.g. two sets of waveguides 513, 523, as to enable reconstruction of respective portions of the incoming optical radiation propagated via each channel 510/520 when the modulated portions of the incoming optical radiation propagated via at least two waveguides are received by a single photodetector 530. Applying such modulation to radiation portions propagated via different sets of waveguides allows using a single photodetector to detect individual contributions from at least two, possibly more, waveguide channels, thus eliminating the need to use a different photodetector for each optical channel of a multi-channel waveguide-based spectrometers. A system such as the spectrometer 500A or 500B may, and typically would, include more than two waveguide channels, e.g. eight channels, and use more than one photodetectors. However, advantages may be realized for any such implementations where the number of photodetectors used is less than the number of different optical channels.

In some embodiments, the one or more modulators 516/526 could be configured to apply orthogonal function modulation, e.g. using a Hadamard orthogonal set of functions, also known as Walsh functions or Hadamard-Walsh functions.

In some embodiments, modulation may be in a form of varying a central wavelength of each portion of the portions of the incoming optical radiation propagated via a respective waveguide of the two or more waveguide channels 510/520. In other embodiments, modulation may be in a form of varying intensity of each portion of the portions of the incoming optical radiation propagated via a respective waveguide of the two or more waveguide channels 510/520.

In various embodiments, the one or more modulators 516/526 may modulate portions of the light propagated through the waveguide channels 510/520 using electrical, thermal, mechanical or electromechanical modulation, i.e. modulation induced by electrical, thermal, mechanical, or electromechanical means, or any combination thereof.

For example, in some implementations, electrical modulation can be performed by employing the plasma dispersion effect in semiconductors such that the refractive index of a waveguiding structure or a portion of a waveguiding structure can be electrically controlled by varying the concentration of carriers in the semiconductor waveguiding structure by means of injecting carriers by applying a forward bias voltage to a P-N junction in the waveguiding structure. In other implementations, such electrical control may be achieved by means of varying the width of P-N junction depletion region by applying a reverse bias voltage to a P-N junction in the waveguiding structure or by means of creating inversion or accumulation region with excess concentration of carriers in semiconductor waveguiding structure by applying an electrostatic potential to a capacitor formed by a dielectric layer and two conducting layers one of which is the semiconductor material of the waveguiding structure. In other implementations, the one or more modulators 516/526 may be configured to perform electrical modulation by employing Kerr or Pockel's electro-optic effect in a material structure optically coupled to a waveguiding structure or a portion of a waveguiding structure.

In other implementations, the one or more modulators 516/526 may be configured to perform thermal modulation by employing the temperature dependence of the refractive index of the material of a waveguiding structure such that a waveguiding structure or a portion of a waveguiding structure can be heated by a local electrical heater located close to the waveguiding structure.

In still other implementations, mechanical or electromechanical modulation can be performed by mechanically varying the distance between optically coupled waveguiding structures. The mechanical variation of the distance can be performed by means of electrostatic force between two conductive materials by applying a voltage between them, or by means of piezoelectric effect where the mechanical displacement is performed by applying a voltage across a volume of a piezoelectric material. The modulated waveguiding structure can be constructed in a variety of ways such as Michelson interferometer, Mach-Zender interferometer, ring resonator or a composition of a number of ring resonators, a directional or contra-directional coupler, a Brag-grating assisted directional or contra-directional coupler, a multi-mode interferometer, an arrayed waveguide grating, a blazed waveguide sidewall grating, an Echelle grating, or a photonic crystal superprism.

For both FIGS. 5A and 5B, the photodetector 530 is configured to receive the modulated portions of the incoming optical radiation propagated via at least two waveguide channels 510 and 520. In some embodiments, existing photodetectors could be used to implement the photodetector 530, as long as such a photodetector is configured to receive modulated radiation supported by the waveguides. Similar to the photodetectors 430 and 440 shown in FIGS. 4A and 4B, in various embodiments, the photodetector 530 could include one, a plurality of, or any combination of a Si photodetector, a Ge photodetector, an InGaAs photodetector, an InAs photodetector, a PbS photodetector, an InSb photodetector, a HgCdTe photodetector, a PbSe photodetector, a GeAu photodetector, a thermistor, a bolometer, a thermocouple, and a pyroelectric detector. While decreasing the amount of detectors to be used for detecting optical radiation in integrated spectrometer applications is advantageous for any kind of photodetectors used, the advantages become particularly substantial when photodetectors being used are those sensitive in spectral regions with wavelengths above 1.7 um, due to high production costs of implementing such detectors in integrated spectrometers.

FIGS. 5A and 5B differ in how the photodetector 530 is configured to receive the modulated portions of the incoming optical radiation propagated via the channels 510 and 520. Namely, FIG. 5A illustrates an embodiment which could be used when the photodetector is implemented on a separate die from a die that houses the input couplers 512/522, the waveguides 513/533, the modulators 516/526, and the optical filters 514/524, in case such filters are implemented. In such an embodiment, the light coming out of the modulators 516/526 is coupled to the photodetector 530 by means of output couplers 518/528, as shown in FIG. 5A. The output couplers 518/528 may include couplers such as the input couplers 512/522, but operated in reverse, i.e. the couple the light out of their corresponding waveguides 513/523 into the free space. The light then travels through free space to reach the photodetector 530, as is shown in FIG. 5A with wavy lines with arrows representing light travelling in free space to the photodetector 530.

On the other hand, FIG. 5B illustrates an embodiment which could be used when the photodetector is implemented on the same die with the input couplers 512/522, the waveguides 513/533, the modulators 516/526, and the optical filters 514/524, in case such filters are implemented. In such an embodiment, the light coming out of the modulators 516/526 is coupled to the photodetector 530 by means of waveguides 513/523 extending between each of the modulators 516/526 and the photodetector 530, as shown in FIG. 5B. As shown in FIG. 5B, all of the waveguides 513/523 are individually connected to the photodetector 530 so that the light propagated in one waveguide does not interfere with the light propagated in any other waveguides. In such an embodiment, the output couplers as the ones shown in FIG. 5A are not needed.

Although not specifically shown in FIGS. 5A and 5B, each of the systems 500A and 500B may further include or be communicatively connected to one or more analog to digital converters (ADCs) communicatively connected to one or more photodetectors employed in the systems 500A/500B and configured to generate digital representation of radiation detected by these photodetectors.

As shown in both FIGS. 5A and 5B, each of the systems 500A and 500B may also include or be communicatively connected to a demodulator 532 configured to receive measurements from the photodetector 530, possibly digital signals from an ADC described above, and to de-modulate the radiation detected by the photodetector 530 to separate the combined radiation received by this single photodetector into respective portions of the incoming optical radiation propagated via each waveguide channel of at least two waveguide channels 510 and 520. In various embodiments, the one or more ADCs and/or one or more demodulators 532 may be implemented on the same semiconductor die where some other spectrometer components are implemented, or may be distributed over a number of different dies.

As also shown in FIGS. 5A and 5B, each of the systems 500A and 500B may further include or be communicative connected to a controller 534 configured to control and/or enable functionalities described herein. For example, the controller 534 may be configured to control modulation applied be the one or more modulators 516/526 (e.g. control a type of modulation applied), control how incoming radiation is divided into channels (e.g. by controlling transfer functions of individual waveguides in each of the channels 510/520), control functionality of the one or more photodetectors 530 (e.g. sensitivity of photodetectors, threshold levels, etc.), control functionality of the ADCs, or/and control functionality of the one or more demodulators 532 (e.g. control a type of demodulation algorithm(s) applied).

Similar to FIGS. 4A and 4B, each of the spectrometer systems 500A and 500B is configured to support propagation of radiation through at least a portion of the two or more channels 510/520 to carry out one or more analytical techniques on the received radiation for determining the spectral content of the received radiation. To that end, similar to FIGS. 4A and 4B, each of FIGS. 5A and 5B further illustrates a spectroscopic evaluation logic 550 configured to receive light measurements from the photodetector 530 and perform spectroscopic evaluation of the sample with which the light interacted. FIG. 6 described below provides an example of a data processing system which may be used to implement the functionality of each of the spectroscopic evaluation logic 550 and the controller 534 shown in FIGS. 5A and 5B.

Other parts of the spectrometer systems 500A and 500B are not shown in FIGS. 5A and 5B in order to not clutter the drawings.

In some embodiments, each of the systems 500A and 500B may include an array of non-modulated micro-ring resonators (not shown in FIGS. 5A and 5B) in which the waveguides are coupled to an array of waveguiding ring resonators or an array of compounds of ring resonators with each resonator having a unique value of the resonant frequency, and each resonator or resonator compound coupled to an output waveguide which is further coupled to a modulator for performing e.g. an amplitude modulation of the intensity of light. In such implementations, each assembly or a structure that includes a ring resonator or a compound of ring resonators together with the associated output waveguide and modulator that it is coupled to, represents a channel of the spectrometer.

In other embodiments, each of the systems 500A and 500B may include an array of modulated micro-ring resonators (not shown in FIGS. 5A and 5B) in which the waveguides are coupled to an array of modulated waveguiding ring resonators or an array of compounds of modulated ring resonators with each resonator having a unique value of the resonant frequency which can be modulated, and each resonator or resonator compound coupled to an output waveguide and comprising a channel of the spectrometer.

In still other embodiments, each of the systems 500A and 500B may include an array of non-modulated wavelength-dispersing integrated structures (not shown in FIGS. 5A and 5B) in which the waveguides are coupled to one or more wavelength dispersing integrated structures such as arrayed waveguide grating, planar staircase profile grating, planar blazed waveguide sidewall grating, planar Echelle grating, a photonic crystal superprism, or a planar multimode interferometer, with each wavelength dispersing integrated structure comprising an array of output waveguides, each of them further coupled to a modulator for performing e.g. an amplitude modulation of the intensity of light and representing a channel of the spectrometer.

In some embodiments, each of the systems 500A and 500B may include an array of modulated wavelength-dispersing integrated structures in which the waveguides are coupled to one or more modulated wavelength dispersing integrated structures such as arrayed waveguide grating, planar staircase profile grating, planar blazed waveguide sidewall grating, planar Echelle grating, a photonic crystal superprism, or a planar multimode interferometer, with the refractive index of the portion or the whole of the said structures being modulated, with each wavelength dispersing integrated structures comprising an array of output waveguides each representing a channel of the spectrometer.

In some embodiments, each of the systems 500A and 500B may be configured to operate as a Fourier-transform spectrometer in which the waveguides are coupled to one or more planar non-modulated Mach-Zender interferometers or one or more planar non-modulated Michelson interferometers, with each interferometer having a unique value of the optical phase difference between interfering portions of the radiation in each interferometer, and each interferometer coupled to an output waveguide which is further coupled to a modulator for performing e.g. an amplitude modulation of the intensity of light. In this way each structure comprising an interferometer together with the output waveguide and modulator that it is coupled to, represents a channel of the spectrometer.

In some embodiments, each of the systems 500A and 500B may be configured to function as a Fourier-transform spectrometer in which the waveguides are coupled to one or more planar modulated Mach-Zender interferometers or one or more modulated Michelson interferometers, with each interferometer having a unique value of the optical phase difference between interfering portions of the radiation in each interferometer which can be modulated, and each interferometer coupled to an output waveguide and comprising a channel of the spectrometer.

A modulation of the center wavelength of each spectral channel or radiation intensity in each spectral channel, as described herein, may be applied to most of the existing semiconductor integrated waveguide-based spectrometer architectures, making the techniques described herein particularly useful. For example, Si waveguiding structures such as ring and disk resonators, Mach-Zender and Michelson interferometers can be modulated electrically using plasma dispersion effect in Si, thermally using the temperature dependence of refractive index of Si, or electromechanically by changing the distance between waveguiding structures by means of mechanical movement of the structures with voltage-controlled electrostatic field. Similar techniques can be applied to other waveguide structures on semiconductor dies such as SiN, SiON, Ge or group III-V semiconductors such as gallium arsenide (GaAs), gallium nitride (GaN), gallium phosphide (GaP), indium arsenide (InAs), indium nitride (InN), or indium phosphide (InP). Again, such modulation can be employed to decrease the number of photodetectors/amplifiers by using e.g. orthogonal set of functions to modulate the center wavelength or radiation intensity in each channel. For example, a Hadamard-Walsh orthogonal set of functions can be used for this purpose. By applying a characteristic Hadamard transform voltage pattern to each modulator in the spectrometer the central wavelength or intensity of each channel can be modulated with a unique orthogonal Hadamard pattern in time domain. The light from the output of each channel can then be combined and directed into a single photodetector, the electrical signal from the photodetector can be amplified, converted to digital signal by ADC and an inverse Hadamard transform can be applied to the signal to retrieve the signal of each spectral channel and obtain the original spectrum of radiation.

Alternatively, for a compromise between the number of photodetectors and the number of modulation patterns, e.g. Hadamard modulation patterns, each of the systems 500A and 500B can be divided into a small number of broad spectral channels with each channel having its own photodetector.

In some embodiments, a spectrometer may be an integrated planar waveguide-based spectrometer which, in general, includes a block or an array of blocks with planar waveguide-based spectrometric units with each unit containing modulators for varying central wavelength or radiation intensity at the output of each spectral channel by means of electrical, thermal or electromechanical modulation.

There may be a variety of embodiments with a variety of spectrometric optical arrangements for the spectrometric unit as known in the art, all of which are within the scope of the present disclosure.

For example, each spectrometric unit may be an array of modulated microdonut or micro-ring resonators similar to a structure with the array of non-modulated microdonut or micro-ring resonators, or an array of non-modulated microdonut or micro-ring resonators with the output intensity of each spectral channel modulated by a radiation intensity modulator.

For example, each spectrometric unit may be an integrated dispersive spectrometer with integrated planar grating with the output intensity of each spectral channel modulated by a radiation intensity modulator.

For example, each spectrometric unit may be an integrated dispersive spectrometer with arrayed waveguide grating with the output intensity of each spectral channel modulated by a radiation intensity modulator.

For example, each spectrometric unit may be an integrated dispersive spectrometer with blazed waveguide sidewall grating with the output intensity of each spectral channel modulated by a radiation intensity modulator.

For example, each spectrometric unit may be an integrated dispersive spectrometer with Echelle grating with the output intensity of each spectral channel modulated by a radiation intensity modulator.

For example, each spectrometric unit may be an integrated dispersive spectrometer with photonic crystal superprism.

For example, each spectrometric unit may be an integrated spectrometer with multimode interferometer with the output intensity of each spectral channel modulated by a radiation intensity modulator.

For example, each spectrometric unit may be an integrated Fourier-transform spectrometer with an array of planar non-modulated Mach-Zender Interferometers with the output intensity of each spectral channel modulated by a radiation intensity modulator.

For example, each spectrometric unit may be an integrated Fourier-transform spectrometer with an array of planar modulated Mach-Zender Interferometers.

For example, each spectrometric unit may be an integrated Fourier-Transform spectrometer with an array of planar modulated Michelson Interferometers.

For example, each spectrometric unit may be an integrated Fourier-Transform spectrometer with an array of planar non-modulated Michelson Interferometers with the output intensity of each spectral channel modulated by a radiation intensity modulator.

### Exemplary Data Processing System

FIG. 6 depicts a block diagram illustrating an exemplary data processing system 600, according to one embodiment of the present disclosure. Such a data processing system could be configured to e.g. function as the spectroscopic evaluation unit 450 or 550, or as a controller, e.g. the controller 434 or 534, of any of the spectrometer systems described herein, the controller configured to ensure that the spectrometer systems operate in according with the embodiments described herein.

As shown in FIG. 6, the data processing system 600 may include at least one processor 602 coupled to memory elements 604 through a system bus 606. As such, the data processing system may store program code within memory elements 604. Further, the processor 602 may execute the program code accessed from the memory elements 604 via a system bus 606. In one aspect, the data processing system may be implemented as a computer that is suitable for storing and/or executing program code. It should be appreciated, however, that the data processing system 600 may be implemented in the form of any system including a processor and a memory that is capable of performing the functions described within this specification.

The memory elements 604 may include one or more physical memory devices such as, for example, local memory 608 and one or more bulk storage devices 610. The local memory may refer to random access memory or other non-persistent memory device(s) generally used during actual execution of the program code. A bulk storage device may be implemented as a hard drive or other persistent data storage device. The processing system 600 may also include one or more cache memories (not shown) that provide temporary storage of at least some program code in order to reduce the number of times program code must be retrieved from the bulk storage device 610 during execution.

Input/output (I/O) devices depicted as an input device 612 and an output device 614, optionally, can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 6 with a dashed line surrounding the input device 612 and the output device 614). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 616 may also, optionally, be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 600, and a data transmitter for transmitting data from the data processing system 600 to said systems, devices and/or networks. Modems, cable modems, and Ethernet cards are examples of different types of network adapter that may be used with the data processing system 600.

As pictured in FIG. 6, the memory elements 604 may store an application 618. In various embodiments, the application 618 may be stored in the local memory 608, the one or more bulk storage devices 610, or apart from the local memory and the bulk storage devices. It should be appreciated that the data processing system 600 may further execute an operating system (not shown in FIG. 6) that can facilitate execution of the application 618. The application 618, being implemented in the form of executable program code, can be executed by the data processing system 600, e.g., by the processor 602. Responsive to executing the application, the data processing system 600 may be configured to perform one or more operations or method steps described herein.

### SELECTED EXAMPLES

Example A1 provides a space-coupled waveguide-based spectrometer system including a spectrometer including a waveguide, the spectrometer configured to support propagation of radiation through at least a portion of the waveguide; and a coupler configured to couple the radiation from free space into the waveguide in absence of fiber-optic coupling.

Example A2 provides the system according to Example A1, where the coupler is integrated on a semiconductor die.

Example A3 provides the system according to Example A2, where at least a part of the spectrometer is integrated on said semiconductor die.

Example A4 provides the system according to any one of Examples A1-3, where the coupler includes a plasmonic coupler.

Example A5 provides the system according to any one of Examples A1-3, where the coupler includes a grating coupler.

Example A6 provides the system according to Example A5, where the grating coupler includes one or more of a one-dimensional grating pattern with parallel grating patterns, a one-dimensional grating pattern with concave grating patterns, a two-dimensional grating structure with two-dimensional array of circular grating elements, and a two-dimensional grating structure with two-dimensional array of rectangular grating elements.

Example A7 provides the system according to any one of Examples A1-6, where the waveguide includes a top surface and a bottom surface, and the radiation is incident on the top surface.

Example A8 provides the system according to any one of Examples A1-6, where the waveguide includes a top surface and a bottom surface, and the radiation is incident on the bottom surface.

Example A9 provides the system according to any one of Examples A1-8, where the waveguide includes a first material having a first dielectric constant at least partially confined by one or more materials having a dielectric constant lower than the first dielectric constant, and where the first material is silicon.

Example A10 provides the system according to any one of Examples A1-8, where the waveguide includes a first material having a first dielectric constant at least partially confined by one or more materials having a dielectric constant lower than the first dielectric constant, and where the first material includes silicon nitride (Si₃N₄).

Example A11 provides the system according to any one of Examples A1-8, where the waveguide includes a first material having a first dielectric constant at least partially confined by one or more materials having a dielectric constant lower than the first dielectric constant, and where the first material includes silicon oxynitride (SiON).

Example A12 provides the system according to any one of Examples A1-8, where the waveguide includes a first material having a first dielectric constant at least partially confined by one or more materials having a dielectric constant lower than the first dielectric constant, and where the first material includes germanium (Ge).

Example A13 provides the system according to any one of Examples A1-8, where the waveguide includes a first material having a first dielectric constant at least partially confined by one or more materials having a dielectric constant lower than the first dielectric constant, and where the first material includes a III-V semiconductor compound.

Example A14 provides the system according to Example A13, where the III-V semiconductor compound includes gallium arsenide (GaAs), gallium nitride (GaN), gallium phosphide (GaP), indium arsenide (InAs), indium nitride (InN), or indium phosphide (InP).

Example A15 provides the system according to any one of Examples A1-8, where the waveguide includes a photonic crystal waveguide.

Example A16 provides the system according to any one of Examples A1-15, where the waveguide includes a single-mode waveguide.

Example A17 provides the system according to any one of the Examples A1-15, where the waveguide includes a multi-mode waveguide.

Example A18 provides the system according to any one of the preceding Examples, where the spectrometer includes an array of non-modulated micro-ring resonators, an array of modulated micro-ring resonators, an integrated dispersive spectrometer with integrated planar grating, an integrated dispersive spectrometer with arrayed waveguide grating, an integrated dispersive spectrometer with blazed waveguide sidewall grating, an integrated dispersive spectrometer with Echelle grating, an integrated dispersive spectrometer with photonic crystal superprism, an integrated spectrometer with multimode interferometer, an integrated Fourier-transform spectrometer with an array of planar non-modulated Mach-Zender interferometers, an integrated Fourier-transform spectrometer with an array of planar modulated Mach-Zender interferometers, an integrated Fourier-transform spectrometer with an array of planar non-modulated Michelson interferometers, or an integrated Fourier-transform spectrometer with an array of planar modulated Michelson interferometers.

Example A19 provides the system according to any one of the preceding Examples, further including a polarizer or/and a polarization splitter configured to ensure that part or all of the radiation propagated through the at least a portion of the waveguide provided to one or more photodetectors included within or associated with the spectrometer is of a predefined radiation polarization.

Example A20 provides the system according to Example A19, where the polarizer or/and the polarization splitter is integrated on the same semiconductor die as the waveguide and/or the coupler.

Example B1 provides an integrated waveguide-based spectrometer configured to detect incoming optical radiation, the spectrometer including two or more waveguides, each waveguide configured to support propagation of at least a portion of the incoming optical radiation; and one or more modulators configured to apply modulation to the portions of the incoming optical radiation propagated via the two or more waveguides to enable reconstruction of respective portions of the incoming optical radiation propagated via each waveguide when the modulated portions of the incoming optical radiation propagated via at least two waveguides are received by one photodetector.

Example B2 provides the spectrometer according to Example B1, further including one or more photodetectors, where at least a first photodetector is configured to receive the modulated portions of the incoming optical radiation propagated via at least two waveguides.

Example B3 provides the spectrometer according to Example B2, where each photodetector of the one or more photodetectors includes one of a Si photodetector, a Ge photodetector, an InGaAs photodetector, an InAs photodetector, a PbS photodetector, an InSb photodetector, a HgCdTe photodetector, a PbSe photodetector, a GeAu photodetector, a thermistor, a bolometer, a thermocouple, and a pyroelectric detector.

Example B4 provides the spectrometer according to Examples B2 or B3, where the one or more photodetectors are integrated on a semiconductor die.

Example B5 provides the spectrometer according to Example B4, where the two or more waveguides are integrated on said semiconductor die.

Example B6 provides the spectrometer according to Examples B2 or B3, where the first photodetector is attached to a semiconductor die that includes the two or more waveguides and is coupled to optical outputs of said at least two waveguides.

Example B7 provides the spectrometer according to Example B6, where the first photodetector is coupled to the optical outputs of said at least two waveguides by means of one or more fiber optic connectors.

Example B8 provides the spectrometer according to any one of Examples B2-7, further including an analog to digital converter communicatively connected to the first photodetector and configured to generate digital representation of radiation detected by the first photodetector.

Example B9 provides the spectrometer according to any one of Examples B2-8, further including a demodulator configured to de-modulate the radiation detected by the first photodetector to separate the combined radiation received by the first photodetector into respective portions of the incoming optical radiation propagated via each waveguide of said at least two waveguides.

Example B10 provides the spectrometer according to any one of the preceding Examples B, where said modulation includes orthogonal function modulation.

Example B11 provides the spectrometer according to Example B10, where said orthogonal function modulation includes modulation using a Hadamard orthogonal set of functions.

Example B12 provides the spectrometer according to any one of Examples B1-11, where said modulation includes varying a central wavelength of each portion of the incoming optical radiation propagated via a respective waveguide.

Example B13 provides the spectrometer according to any one of Examples B1-11, where said modulation includes varying intensity of each portion of the incoming optical radiation propagated via a respective waveguide.

Example B14 provides the spectrometer according to any one of the preceding Examples B, where said modulation includes electrical, thermal, mechanical or electromechanical modulation.

Example B15 provides the spectrometer according to any one of Examples B1-14, where each waveguide includes a first material having a first dielectric constant at least partially confined by one or more materials having a dielectric constant lower than the first dielectric constant, and where the first material is silicon.

Example B16 provides the spectrometer according to any one of Examples B1-14, where each waveguide includes a first material having a first dielectric constant at least partially confined by one or more materials having a dielectric constant lower than the first dielectric constant, and where the first material includes silicon nitride (Si₃N₄).

Example B17 provides the spectrometer according to any one of Examples B1-14, where each waveguide includes a first material having a first dielectric constant at least partially confined by one or more materials having a dielectric constant lower than the first dielectric constant, and where the first material includes silicon oxynitride (SiON).

Example B18 provides the spectrometer according to any one of Examples B1-14, where each waveguide includes a first material having a first dielectric constant at least partially confined by one or more materials having a dielectric constant lower than the first dielectric constant, and where the first material includes germanium (Ge).

Example B19 provides the spectrometer according to any one of Examples B1-14, where each waveguide includes a first material having a first dielectric constant at least partially confined by one or more materials having a dielectric constant lower than the first dielectric constant, and where the first material includes a III-V semiconductor compound.

Example B20 provides the spectrometer according to Example B19, where the III-V semiconductor compound includes gallium arsenide (GaAs), gallium nitride (GaN), gallium phosphide (GaP), indium arsenide (InAs), indium nitride (InN), or indium phosphide (InP).

Example B21 provides the spectrometer according to any one of Examples B1-14, where each waveguide includes a photonic crystal waveguide.

Example B22 provides the spectrometer according to any one of Examples B1-21, where each waveguide includes a single-mode waveguide.

Example B23 provides the spectrometer according to any one of Examples B1-21, where each waveguide includes a multi-mode waveguide.

Example B24 provides the spectrometer according to any one of Examples B1-23, further including an array of non-modulated or modulated micro-ring resonators.

Example B25 provides the spectrometer according to any one of Examples B1-23, further including one or more wavelength dispersing integrated structures.

Example B26 provides the spectrometer according to Example B25, where the one or more wavelength dispersing integrated structures include one or more of non-modulated or modulated integrated planar gratings, non-modulated or modulated integrated arrayed waveguide gratings, non-modulated or modulated integrated blazed waveguide sidewall gratings, non-modulated or modulated integrated Echelle gratings, and non-modulated or modulated integrated photonic crystal superprisms.

Example B27 provides the spectrometer according to any one of Examples B1-23, further including one or more non-modulated or modulated multimode interferometers.

Example B28 provides the spectrometer according to any one of Examples B1-23, further including integrated Fourier-transform spectrometer including an array of planar non-modulated or modulated Mach-Zender interferometers, or an array of planar non-modulated or modulated Michelson interferometers.

Example C1 provides an integrated waveguide-based spectrometer system for spectroscopic evaluation of a sample based on light that has interacted with the sample, the system including a first and a second sets of waveguides, each set including at least one, but preferably two or more waveguides, each waveguide configured to support propagation of at least a portion of the light that has interacted with the sample; a set of input couplers including a respective input coupler associated with each waveguide of the first and the second sets of waveguides by being configured to couple the portion of the light from free space into the waveguide in absence of fiber-optic coupling; and one or more modulators configured to apply modulation to the portions of the light propagated via each set of waveguides to enable reconstruction of respective portions of the light propagated via each set of waveguides when the modulated portions of the light propagated via the first and the second sets of waveguides are received by a single photodetector.

Example C2 provides the system according to Example C1, where the first and the second sets of waveguides, the set of input couplers, and the one or more modulators are integrated on a single semiconductor die.

Example C3 provides the system according to Example C1, where each input coupler includes a grating coupler including one or more of a one-dimensional grating pattern with parallel grating patterns, a one-dimensional grating pattern with concave grating patterns, a two-dimensional grating structure with two-dimensional array of circular grating elements, or a two-dimensional grating structure with two-dimensional array of rectangular grating elements.

Example C4 provides the system according to Example C1, further including a set of optical filters including a respective optical filter associated with each waveguide of the first and the second sets of waveguides by being configured to filter the portion of the light propagated via the waveguide.

Example C5 provides the system according to Example C4, where the first and the second sets of waveguides, the set of input couplers, the one or more modulators, and the set of optical filters are integrated on a single semiconductor die.

Example C6 provides the system according to Example C5, where the set of optical filters includes Lyot filters.

Example C7 provides the system according to Example C5, where the set of optical filters includes ring resonators.

Example C8 provides the system according to Example C5, where the set of optical filters includes multimode interferometers.

Example C9 provides the system according to Example C5, where the set of optical filters includes Bragg grating assisted contra-directional couplers.

Example C10 provides the system according to Example C1, further including a set of output couplers including a respective output coupler associated with each waveguide of the first and the second sets of waveguides by being configured to couple the modulated portion of the light propagated via each waveguide out of the waveguide to free space to be incident on the photodetector.

Example C11 provides the system according to Example C10, where the first and the second sets of waveguides, the set of input couplers, the one or more modulators, and the set of output couplers are integrated on a single semiconductor die, and the photodetector is implemented on a different semiconductor die.

Example C12 provides the system according to Example C1, where the first and the second sets of waveguides, the set of input couplers, the one or more modulators, and the photodetector are integrated on a single semiconductor die, and the one or more modulators are coupled to the photodetector via respective waveguide of the first and the second sets of waveguides.

Example C13 provides the system according to Example C1, where the modulation includes orthogonal function modulation.

Example C14 provides the system according to Example C13, where the orthogonal function modulation includes modulation using a Hadamard orthogonal set of functions.

Example C15 provides the system according to any one of Examples C1-14, where the modulation includes varying intensity of each portion of the light propagated via a respective waveguide.

In various embodiments, the modulation may include electrical, thermal, mechanical or electromechanical modulation.

Example C16 provides the system according to any one of Examples C1-14, where the one or more modulators include Mach-Zender interferometers with the optical path length difference between two interferometer paths modulated by means of electrical (plasma effect) or thermal modulation. There are other possible implementations such as modulated Michelson interferometers or ring resonators.

Example C17 provides the system according to any one of Examples C1-14, where each set of waveguides includes two or more waveguides and where, for each set of waveguides, respective portions of the light propagated via each waveguide of the set of waveguides are provided to the photodetector separately from one another (i.e. the light propagated by the different waveguides of a single channel is not combined until the waveguide is connected to the photodetector).

Example C18 provides the system according to any one of Examples C1-14, further including a demodulator configured to de-modulate the light received by the photodetector to separately detect the respective portions of the light propagated via each set of waveguides.

Example C19 provides the system according to any one of Examples C1-14, further including a processing logic configured to perform the spectroscopic evaluation of the sample based on the light detected by the photodetector.

Example C20 provides the system according to any one of Examples C1-14, where each waveguide includes a first material having a first dielectric constant at least partially confined by one or more materials having a dielectric constant lower than the first dielectric constant, and where the first material is silicon.

Example C21 provides the system according to any one of Examples C1-14, where each waveguide includes a first material having a first dielectric constant at least partially confined by one or more materials having a dielectric constant lower than the first dielectric constant, and where the first material includes silicon nitride (Si₃N₄).

Example C22 provides the system according to any one of Examples C1-14, where each waveguide includes a first material having a first dielectric constant at least partially confined by one or more materials having a dielectric constant lower than the first dielectric constant, and where the first material includes silicon oxynitride (SiON).

Example C23 provides the system according to any one of Examples C1-14, where each waveguide includes a first material having a first dielectric constant at least partially confined by one or more materials having a dielectric constant lower than the first dielectric constant, and where the first material includes germanium (Ge).

Example C24 provides the system according to any one of Examples C1-14, where each waveguide includes a first material having a first dielectric constant at least partially confined by one or more materials having a dielectric constant lower than the first dielectric constant, and where the first material includes a III-V semiconductor compound.

Example C25 provides the system according to Example C24, where the III-V semiconductor compound includes gallium arsenide (GaAs), gallium nitride (GaN), gallium phosphide (GaP), indium arsenide (InAs), indium nitride (InN), or indium phosphide (InP).

Example C26 provides the system according to any one of Examples C1-14, where each waveguide includes a photonic crystal waveguide.

Example C27 provides the system according to any one of Examples C1-14, where each waveguide includes a single-mode waveguide.

Example C28 provides the system according to any one of Examples C1-14, where each waveguide includes a multi-mode waveguide.

Example C29 provides the system according to any one of Examples C1-14, further including a set of polarizers or polarization splitters configured to ensure that part or all of the light propagated through each waveguide is of a predefined radiation polarization.

Example C30 provides the system according to Example C29, where the set of polarizers or polarization splitters integrated on the same semiconductor die as the first and the second sets of waveguides and the set of input couplers.

Example C31 provides the system according to any one of Examples C1-14, where each waveguide includes a top surface and a bottom surface, and the light is incident on the top surface.

Example C32 provides the system according to any one of Examples C1-14, where each waveguide includes a top surface and a bottom surface, and the light is incident on the bottom surface.

Example C33 provides an integrated waveguide-based spectrometer system for spectroscopic evaluation of a sample based on light that has interacted with the sample, the system including a waveguide configured to support propagation of at least a portion of the light that has interacted with the sample; an input coupler configured to couple the portion of the light from free space into the waveguide in absence of fiber-optic coupling; and an optical filter configured to filter the portion of the light propagated via the waveguide.

Example C34 provides the system according to Example C33, where the waveguide, the input coupler, and the optical filter are integrated on a single semiconductor die.

Example C35 provides the system according to Example C33, further including an output coupler configured to couple the light propagated via the waveguide to a photodetector.

Example C36 provides the system according to Example C35, where the waveguide, the input coupler, the optical filter, and the photodetector are integrated on a single semiconductor die.

Example C37 provides the system according to Examples C35 or 36, further including a processing logic configured to perform the spectroscopic evaluation of the sample based on the light detected by the photodetector.

Example 38 provides an integrated waveguide-based spectrometer system for spectroscopic evaluation of a sample based on light that has interacted with the sample, the system including a first input coupler and a first waveguide, the first input coupler configured to couple, from free-space and in absence of fiber-optic coupling, a first portion of the light that has interacted with the sample into the first waveguide; and a second input coupler and a second waveguide, the second input coupler configured to couple, from free-space and in absence of fiber-optic coupling, a second portion of the light that has interacted with the sample into the second waveguide, where an optical output of each of the first waveguide and the second waveguide is separately coupled to an optical input of a photodetector.

Example C39 provides the system according to Example C38, where the first portion of the light propagated via the first waveguide and the second portion of the light propagated via the second waveguide are first combined when both the first portion and the second portion are incident on the photodetector.

Example C40 provides the system according to Examples C38 or 39, where the first input coupler and the second input coupler are different instances of same input coupler, and where the first waveguide and the second waveguide are different instances of same waveguide.

Example C41 provides the system according to Example C38, where the first input coupler and the first waveguide form part of a first sub-channel of a first channel of the system, the second input coupler and the second waveguide form part of a second sub-channel of the first channel of the system, and the system further includes a third input coupler and a third waveguide forming part of a first sub-channel of a second channel of the system, the third input coupler configured to couple, from free-space and in absence of fiber-optic coupling, a third portion of the light that has interacted with the sample into the third waveguide; and a fourth input coupler and a fourth waveguide forming part of a second sub-channel of a second channel of the system, the fourth input coupler configured to couple, from free-space and in absence of fiber-optic coupling, a fourth portion of the light that has interacted with the sample into the fourth waveguide.

Example C42 provides the system according to Example C41, where an optical output of each of the third waveguide and the fourth waveguide is separately coupled to the optical input of the photodetector.

Example C43 provides the system according to Example C41, further including one or more modulators configured to apply different modulation to respective portions of the light propagated via the first channel and the second channel to enable differentiation between the respective portions of the light propagated via each of the first and the second channels when the modulated portions of the light propagated via the first and the second channels are received by the photodetector (i.e. received by a single photodetector).

Example C44 provides the system according to Example C43, where applying different modulation includes applying modulation using a first function to the first portion of the light propagated via the first waveguide and the second portion of the light propagated via the second waveguide, and applying modulation using a second function to the third portion of the light propagated via the third waveguide and the fourth portion of the light propagated via the fourth waveguide, where the first function and the second function are Hadamard orthogonal functions.

Example C45 provides the system according to any one of Examples C41-44, where each of the first input coupler and the second input coupler have a first center wavelength, and each of the third input coupler and the fourth input coupler have a second center wavelength that is different from the first center wavelength.

Example C46 provides the system according to Example C45, further including a first optical filter configured to filter the first portion of the light propagated via the first waveguide; a second optical filter configured to filter the second portion of the light propagated via the second waveguide; a third optical filter configured to filter the third portion of the light propagated via the third waveguide; and a fourth optical filter configured to filter the fourth portion of the light propagated via the fourth waveguide.

Example C47 provides the system according to Example C46, where each of the first optical filter and the second optical filter are configured to pass light in a first band (i.e. range) of wavelengths, and each of the third optical filter and the fourth optical filter are configured to pass light in a second band of wavelengths that includes at least some wavelength different from wavelengths of the first band of wavelengths.

Example C48 provides the system according to any one of Examples C41-44, where the one or more modulators include Mach-Zender interferometers.

Example C49 provides the system according to any one of Examples C41-44, further including a demodulator configured to de-modulate the light received by the photodetector to separately detect the respective portions of the light propagated via each of the first and the second channels.

Example C50 provides the system according to Example C41, where the photodetector is a first photodetector, and where an optical output of each of the third waveguide and the fourth waveguide is separately coupled to an optical input of a second photodetector.

Example C51 provides the system according to any one of Examples C33-50, where each input coupler includes a grating coupler including one or more of a one-dimensional grating pattern with parallel grating patterns, a one-dimensional grating pattern with concave grating patterns, a two-dimensional grating structure with two-dimensional array of circular grating elements, or a two-dimensional grating structure with two-dimensional array of rectangular grating elements.

Example C52 provides the system according to any one of Examples C33-51, where each optical filter includes a Lyot filter or a cascade of Lyot filters, a ring resonator or a cascade of ring resonators, a multimode interferometer or a cascade of multimode interferometers, or a Bragg grating assisted contra-directional coupler or a cascade of Bragg grating assisted contra-directional couplers.

Example C53 provides the system according to any one of Examples C33-52, where each waveguide includes a first material having a first dielectric constant at least partially confined by one or more materials having a dielectric constant lower than the first dielectric constant, and where the first material is silicon.

Example C54 provides the system according to any one of Examples C33-52, where each waveguide includes a first material having a first dielectric constant at least partially confined by one or more materials having a dielectric constant lower than the first dielectric constant, and where the first material includes silicon nitride (Si₃N₄).

Example C55 provides the system according to any one of Examples C33-52, where each waveguide includes a first material having a first dielectric constant at least partially confined by one or more materials having a dielectric constant lower than the first dielectric constant, and where the first material includes silicon oxynitride (SiON).

Example C56 provides the system according to any one of Examples C33-52, where each waveguide includes a first material having a first dielectric constant at least partially confined by one or more materials having a dielectric constant lower than the first dielectric constant, and where the first material includes germanium (Ge).

Example C57 provides the system according to any one of Examples C33-52, where each waveguide includes a first material having a first dielectric constant at least partially confined by one or more materials having a dielectric constant lower than the first dielectric constant, and where the first material includes a III-V semiconductor compound.

Example C58 provides the system according to Example C57, where the III-V semiconductor compound includes gallium arsenide (GaAs), gallium nitride (GaN), gallium phosphide (GaP), indium arsenide (InAs), indium nitride (InN), or indium phosphide (InP).

Example C59 provides the system according to any one of Examples C33-52, where each waveguide includes a photonic crystal waveguide.

Example C60 provides the system according to any one of Examples C33-52, where each waveguide includes a single-mode waveguide.

Example C61 provides the system according to any one of Examples C33-52, where each waveguide includes a multi-mode waveguide.

Example C62 provides the system according to any one of Examples C33-52, further including a set of polarizers or polarization splitters configured to ensure that part or all of the light propagated through each waveguide is of a predefined radiation polarization.

Example C63 provides the system according to any one of Examples C33-62, where each waveguide includes a top surface and a bottom surface, and the light is incident on the top surface.

Example C64 provides the system according to any one of Examples C33-62, where each waveguide includes a top surface and a bottom surface, and the light is incident on the bottom surface.

### Variations and Implementations

In the discussions of the embodiments above, various components can readily be replaced, substituted, or otherwise modified in order to accommodate particular circuitry needs. Moreover, it should be noted that the use of complementary electronic devices, hardware, software, etc. offer an equally viable option for implementing the teachings of the present disclosure.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

In another example embodiment, the electrical circuits of the FIGURES may be implemented as stand-alone modules (e.g., a device with associated components and circuitry configured to perform a specific application or function) or implemented as plug-in modules into application specific hardware of electronic devices. Note that particular embodiments of the present disclosure may be readily included in a system on chip (SOC) package, either in part, or in whole. An SOC represents an IC that integrates components of a computer or other electronic system into a single chip. It may contain digital, analog, mixed-signal, and often radio frequency functions: all of which may be provided on a single chip substrate. Other embodiments may include a multi-chip-module (MCM), with a plurality of separate ICs located within a single electronic package and configured to interact closely with each other through the electronic package. In various other embodiments, the overload protection functionalities may be implemented in one or more silicon cores in Application Specific Integrated Circuits (ASICs), Field Programmable Gate Arrays (FPGAs), and other semiconductor chips.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular processor and/or component arrangements. Various modifications and changes may be made to such embodiments without departing from the scope of the appended claims. The description and drawings are, accordingly, to be regarded in an illustrative rather than in a restrictive sense.

Note that the activities discussed above with reference to the FIGURES are applicable to any integrated circuits that involve signal processing, particularly those that can execute specialized software programs, or algorithms, some of which may be associated with converting an analog signal to a digital signal and processing such digital signal. Certain embodiments can relate to multi-DSP signal processing, floating point processing, signal/control processing, fixed-function processing, microcontroller applications, etc. In certain contexts, the features discussed herein can be applicable to medical systems, scientific instrumentation, wireless and wired communications, radar, industrial process control, audio and video equipment, current sensing, instrumentation (which can be highly precise), and other digital-processing-based systems utilizing a delta-sigma ADC. Moreover, certain embodiments discussed above can be provisioned in digital signal processing technologies for medical imaging, patient monitoring, medical instrumentation, and home healthcare. This could include pulmonary monitors, accelerometers, heart rate monitors, pacemakers, etc. Other applications can involve automotive technologies for safety systems (e.g., stability control systems, driver assistance systems, braking systems, infotainment and interior applications of any kind). Furthermore, powertrain systems (for example, in hybrid and electric vehicles) can use high-precision or high-speed data conversion products in battery monitoring, control systems, reporting controls, maintenance activities, etc. In yet other example scenarios, the teachings of the present disclosure can be applicable in the industrial markets that include process control systems that help drive productivity, energy efficiency, and reliability. In consumer applications, the teachings of the signal processing circuits discussed above can be used for products related to image processing.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the apparatus described above may also be implemented with respect to the method or process described herein and specifics in the examples may be used anywhere in one or more embodiments.

1. An integrated waveguide-based spectrometer system for spectroscopic evaluation of a sample based on light that has interacted with the sample, the system comprising:
a first and a second sets of waveguides, each set comprising two or more waveguides, each waveguide configured to support propagation of at least a portion of the light that has interacted with the sample;
a set of input couplers comprising a input coupler associated with each waveguide of the first and the second sets of waveguides by being configured to couple the portion of the light from free space into the waveguide in absence of fiber-optic coupling; and
one or more modulators configured to apply modulation to the portions of the light propagated via each set of waveguides to enable reconstruction of respective portions of the light propagated via each set of waveguides when the modulated portions of the light propagated via the first and the second sets of waveguides are received by a single photodetector.

2. The system according to claim 1, wherein the first and the second sets of waveguides, the set of input couplers, and the one or more modulators are integrated on a single semiconductor die.

3. The system according to claim 1, further comprising a set of optical filters comprising an optical filter associated with each waveguide of the first and the second sets of waveguides by being configured to filter the portion of the light propagated via the waveguide.

4. The system according to claim 3, wherein the first and the second sets of waveguides, the set of input couplers, the one or more modulators, and the set of optical filters are integrated on a single semiconductor die.

5. The system according to claim 4, wherein the set of optical filters comprises Lyot filters.

6. The system according to claim 1, further comprising:
a set of output couplers comprising an output coupler associated with each waveguide of the first and the second sets of waveguides by being configured to couple the modulated portion of the light propagated via each waveguide out of the waveguide to free space to be incident on the photodetector.

7. The system according to claim 6, wherein the first and the second sets of waveguides, the set of input couplers, the one or more modulators, and the set of output couplers are integrated on a single semiconductor die, and the photodetector is implemented on a different semiconductor die.

8. The system according to claim 1, wherein the first and the second sets of waveguides, the set of input couplers, the one or more modulators, and the photodetector are integrated on a single semiconductor die, and the one or more modulators are coupled to the photodetector via respective waveguide of the first and the second sets of waveguides.

9. An integrated waveguide-based spectrometer system for spectroscopic evaluation of a sample based on light that has interacted with the sample, the system comprising:
a first input coupler and a first waveguide, the first input coupler configured to couple, from free-space and in absence of fiber-optic coupling, a first portion of the light that has interacted with the sample into the first waveguide; and
a second input coupler and a second waveguide, the second input coupler configured to couple, from free-space and in absence of fiber-optic coupling, a second portion of the light that has interacted with the sample into the second waveguide,
wherein an optical output of each of the first waveguide and the second waveguide is separately coupled to an optical input of a photodetector.

10. The system according to claim 9, wherein the first portion of the light propagated via the first waveguide and the second portion of the light propagated via the second waveguide are first combined when both the first portion and the second portion are incident on the photodetector.

11. The system according to claim 9, wherein the first input coupler and the second input coupler are different instances of same input coupler, and wherein the first waveguide and the second waveguide are different instances of same waveguide.

12. The system according to claim 9, wherein:
the first input coupler and the first waveguide form part of a first sub-channel of a first channel of the system,
the second input coupler and the second waveguide form part of a second sub-channel of the first channel of the system, and
the system further comprises:
a third input coupler and a third waveguide forming part of a first sub-channel of a second channel of the system, the third input coupler configured to couple, from free-space and in absence of fiber-optic coupling, a third portion of the light that has interacted with the sample into the third waveguide; and
a fourth input coupler and a fourth waveguide forming part of a second sub-channel of a second channel of the system, the fourth input coupler configured to couple, from free-space and in absence of fiber-optic coupling, a fourth portion of the light that has interacted with the sample into the fourth waveguide.

13. The system according to claim 12, wherein an optical output of each of the third waveguide and the fourth waveguide is separately coupled to the optical input of the photodetector.

14. The system according to claim 12, further comprising one or more modulators configured to apply different modulation to respective portions of the light propagated via the first channel and the second channel to enable differentiation between the respective portions of the light propagated via each of the first and the second channels when the modulated portions of the light propagated via the first and the second channels are received by the photodetector.

15. The system according to claim 14, wherein applying different modulation comprises:
applying modulation using a first function to the first portion of the light propagated via the first waveguide and the second portion of the light propagated via the second waveguide, and
applying modulation using a second function to the third portion of the light propagated via the third waveguide and the fourth portion of the light propagated via the fourth waveguide,
wherein the first function and the second function are Hadamard orthogonal functions.

16. The system according to claim 12, wherein:
each of the first input coupler and the second input coupler have a first center wavelength, and
each of the third input coupler and the fourth input coupler have a second center wavelength that is different from the first center wavelength.

17. The system according to claim 16, further comprising a first optical filter configured to filter the first portion of the light, a second optical filter configured to filter the second portion of the light, a third optical filter configured to filter the third portion of the light, and a fourth optical filter configured to filter the fourth portion of the light.

18. The system according to claim 17, wherein:
each of the first optical filter and the second optical filter are configured to pass light in a first band of wavelengths, and
each of the third optical filter and the fourth optical filter are configured to pass light in a second band of wavelengths that includes at least some wavelength different from wavelengths of the first band of wavelengths.

19. The system according to claim 12, wherein the one or more modulators comprise Mach-Zender interferometers.

20. The system according to claim 12, further comprising a demodulator configured to de-modulate the light received by the photodetector to separately detect the respective portions of the light propagated via each of the first and the second channels.
